(19) United States
(12) Patent Application Publication
(10) Pub. No.: US 2026/0050565 A1
(43) Pub. Date: Feb. 19, 2026

(54) REAL-TIME DATA TRANSFER SCHEME FROM LIMITED POWER EMBEDDED SYSTEMS

(71) Applicant: NEC Laboratories America, Inc., Princeton, NJ (US)

(72) Inventor: Junqiang HU, DAVIS, CA (US)

(73) Assignee: NEC Laboratories America, Inc., Princeton, NJ (US)

(21) Appl. No.: 19/218,439

(22) Filed: May 26, 2025

Related U.S. Application Data
(60) Provisional application No. 63/652,276, filed on May 28, 2024.

(51) Int. Cl. G06F 13/28; G01H 9/00; G06F 13/16

(52) U.S. Cl. CPC G06F 13/28; G01H 9/004; G06F 13/1673

(57) ABSTRACT

Distributed fiber optic sensing (DFOS)/distributed acoustic sensing (DAS) that illustrate inventive techniques—applicable to all embedded systems—that deliver high-bandwidth traffic from a DFOS system to a cloud or other processing resources in real-time, employ firmware that operates at a register-transfer level and writes data repeatedly into the embedded host memory directly—without software intervention after initial configuration. This technique advantageously enables the use of the relatively large host memory to compensate for any software jitter. Preferably configured, the firmware employs only a small buffer to compensate for a transaction and host-memory arbitration latency. A second dedicated thread sends out data from the user space buffer to a cloud, or a connected server. Remote procedures that are executed on a remote system (a computer, network of computers, or cloud), receive data transmitted from the embedded system, and perform further processing as necessary.

### CROSS REFERENCE TO RELATED APPLICATIONS

This application claims the benefit of United States Provisional Patent Application Ser. No. 63/652,276 filed May 28, 2024, the entire contents of which is incorporated by reference as if set forth at length herein.

### FIELD OF THE INVENTION

This application relates broadly to embedded systems and distributed fiber optic sensing (DFOS) systems, methods, and structures. More particularly, it pertains to embedded systems employed in DFOS applications that must deliver high-bandwidth traffic to another system including cloud systems in real time.

### BACKGROUND OF THE INVENTION

For contemporary applications using distributed fiber optic sensing, the amount of data generated is determined by interrogating signal repetition rate (which is considered as “sampling rate” for each location), spatial resolution, and optical fiber length, which is usually close-to or above 1 Gigabit/second for each fiber channel employed. While DFOS data can be processed locally in certain cases, there exist many more cases that require deep machine learning, or customer specific processing (such as in seismology science), in which a large amount of data must be sent to cloud services or a dedicated server for processing in real-time. When field deployed DFOS systems utilize limited resource computing structures such as an embedded process or a system on a chip (SoC), output data is oftentimes sent via high-overhead software stacks that can limit overall throughput.

### SUMMARY OF THE INVENTION

The above problems are solved, and an advance is made in the art according to aspects of the present disclosure directed to techniques facilitating the delivery of high-bandwidth traffic from distributed fiber optic sensing systems employing embedded systems to a cloud or other remote system in real-time.

In sharp contrast to the prior art, systems and methods according to aspects of the present disclosure employ a cyclic Direct Memory Access (DMA) technique that writes data from firmware to host memory organized in a cyclic mode. The firmware uses one bit in writing data to notify a driver about data availability and driver code checks and clears this bit for availability and overflow status monitoring.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing an illustrative portable system according to aspects of the present disclosure.

FIG. 3 is a schematic diagram showing illustrative firmware, kernel driver and user space software for systems according to aspects of the present disclosure.

FIG. 4 is a schematic flow diagram showing illustrative processing flow chart according to aspects of the present disclosure.

FIG. 5 is a schematic block diagram showing illustrative buffers organized in a loop mode according to aspects of the present disclosure.

FIG. 6 is a schematic diagram showing illustrative firmware data with output according to aspects of the present disclosure.

FIG. 7 is a schematic flow diagram showing illustrative DMA transaction according to aspects of the present disclosure.

FIG. 8 is a schematic flow diagram showing illustrative kernel driver flow according to aspects of the present disclosure.

FIG. 9 is a schematic flow diagram showing illustrative memory operation flow in software according to aspects of the present disclosure.

FIG. 10 is a schematic flow diagram showing illustrative data reading thread in user space according to aspects of the present disclosure.

FIG. 11 is a schematic flow diagram showing illustrative data sending thread flow in user space software according to aspects of the present disclosure.

FIG. 12 shows a feature diagram in hierarchical format of illustrative features and operation steps of systems and methods according to aspects of the present disclosure.

FIG. 13 is a schematic block diagram of an illustrative computer system in which aspects of the present disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

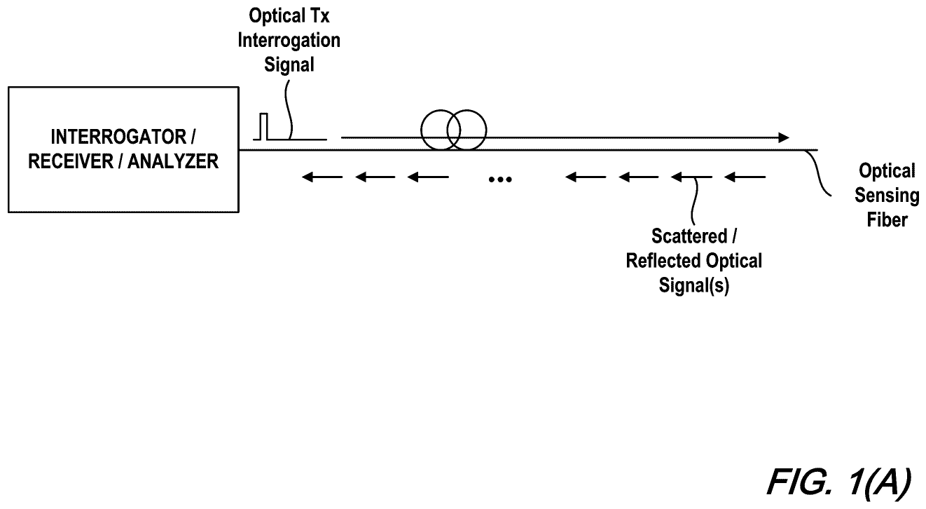

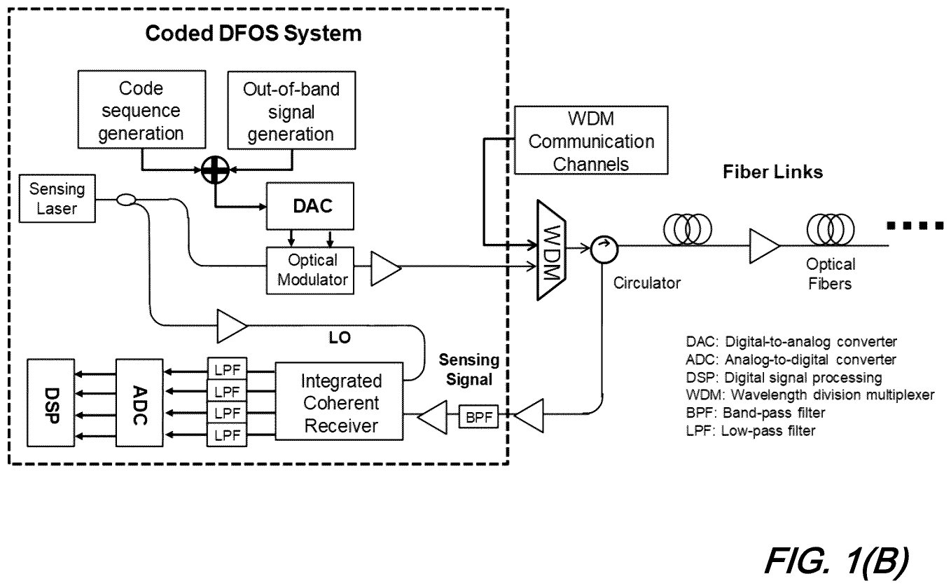

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyze reflected/backscattered and subsequently received signal(s). The signals received are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration or an indication of temperature.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered, and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level optical fiber cable sensor resolution.

In distributed fiber optic sensing, the amount of data generated is determined by the interrogating signal repetition rate (which is considered as the “sampling rate” for each location), the spatial resolution, and the fiber length, which is usually close-to or above 1 Gigabit/second for each optical fiber channel. Although in some systems such large amounts of data can be processed locally and provide only a decision to a user, there are more situations that require deep machine learning, or customer specific processing (such as in seismology science), in which the large volume of DFOS data must be sent to the cloud or a dedicated server in real-time for processing.

For a system that works remotely—in the field—its mechanical dimension and power consumption are among key parameters that must be managed. For example, to achieve an acceptable low power consumption and compact physical size, such remote systems would likely employ an embedded processor, or system-on-chip (SoC) device.

As those skilled in the art will readily understand and appreciate, generally, the processing power and bandwidth of an embedded processor are limited. And while dedicated firmware may handle any necessary signal processing in real-time, data output may encounter significant jitter, which may cause a bottleneck to overall system throughput.

Advantageously, systems and methods according to aspects of the present invention provide techniques—applicable to all embedded systems—that deliver high-bandwidth traffic from a DFOS system to a cloud or other processing resources in real-time.

Operationally, our inventive systems and methods may include the following techniques.

Our inventive systems and methods employ firmware that operates at a register-transfer level and writes data repeatedly into the embedded host memory directly—without software intervention after an initial configuration. This technique advantageously enables the use of the relatively large host memory to compensate for any software jitter. As preferably configured, the firmware employs only a small buffer to compensate for a transaction and host-memory arbitration latency.

Our inventive systems and methods employ driver code, which is low-level software that configures the firmware, interacts with user space software, and copies data from host memory to user space upon request. The driver code allocates a relatively large buffer in kernel space for the firmware to write the data, which compensates for any user-space processing jitter.

Our inventive systems and methods employ a dedicated thread in the user space to request data from the driver and notify another thread about the availability of data. User space software employs a large buffer that compensates for both processing jitter and network interaction jitter.

Our inventive systems and methods employ a second dedicated thread that sends out data from the user space buffer to a cloud, or a connected server. Remote procedures that execute on a remote system (a computer, network of computers, or cloud), receive data transmitted from the embedded system, and performs further processing as necessary.

As we shall show and describe in greater detail, our inventive systems and methods according to aspects of the present disclosure employ “cyclic DMA” techniques, which write the data from the firmware to the host memory organized in cyclic mode. Firmware uses one bit when writing data to notify a driver about data availability and executing driver code checks and clears this one bit for availability and overflow status monitoring.

As we shall show and describe in greater detail, overall operation according to aspects for the present disclosure exhibits one the following characteristics.

Firmware repeatedly writes data into the cyclic buffer in host memory without processor involvement. Driver software is responsible for monitoring data availability and the buffer's fullness. As will be understood and appreciated by those skilled in the art, this process is advantageously performed by checking the valid bit (set by the firmware and cleared by the software). User application software uses multi-thread processing to isolate transactions with the firmware, and with the remote host.

The firmware writing buffer is divided into multiple segments or used as “frames”; each frame used has bit set by the firmware and cleared by the software and used for both valid and full status indicator.

As those skilled in art will understand and appreciate further, employing user space has the advantage in flexible data handling, and the ability to use inexpensive buffer to compensate for the processing or network jitter. A dedicated reading thread isolate the processing or network jitter from kernel interaction, which simplifies the driver design and avoids DMA transaction overflow.

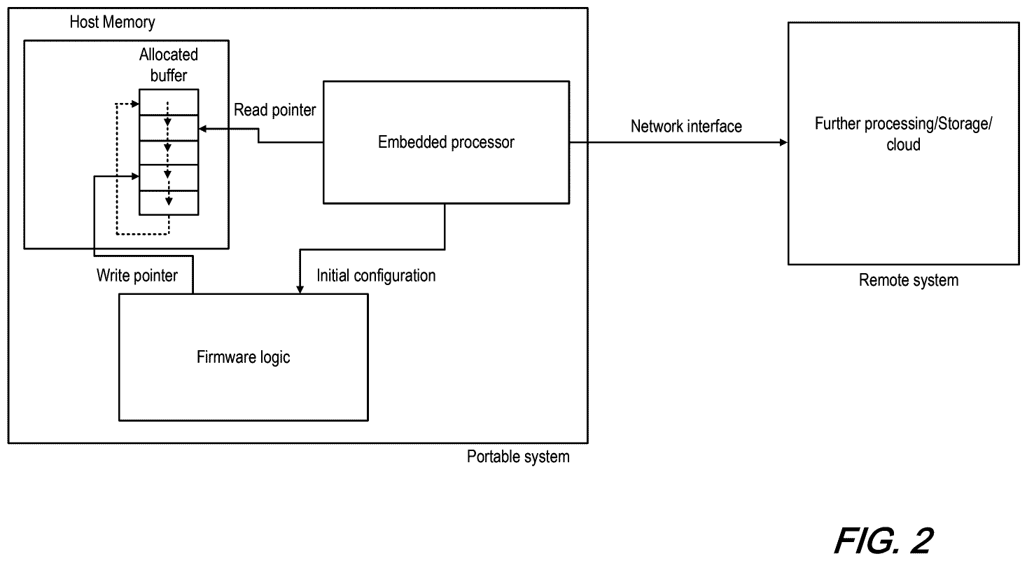

FIG. 2 is a schematic diagram showing an illustrative portable system according to aspects of the present disclosure. The portable system, illustratively a distributed acoustic sensing (DAS) system, generates a large amount of data in real-time. The DAS data is sent to another system (here called the remote system), such as a computer, or a storage server, or the cloud, for further processing/data storage, through a network interface.

Inside the portable system, the firmware, such as FPGA (Field Programmable Gate Array) logic, or the logic inside ASIC (Application Specific Integrated Circuit), is a data source of traffic sent to the remote system. It performs necessary processing on input data, such as ADC (Analog-to-Digital Converter) sampled input, and generates the high-speed real-time output. This data is written directly from the firmware to the host (here the embedded microprocessor) memory using DMA (Direct Memory Access) method. The microprocessor then reads from the same memory and sends it out.

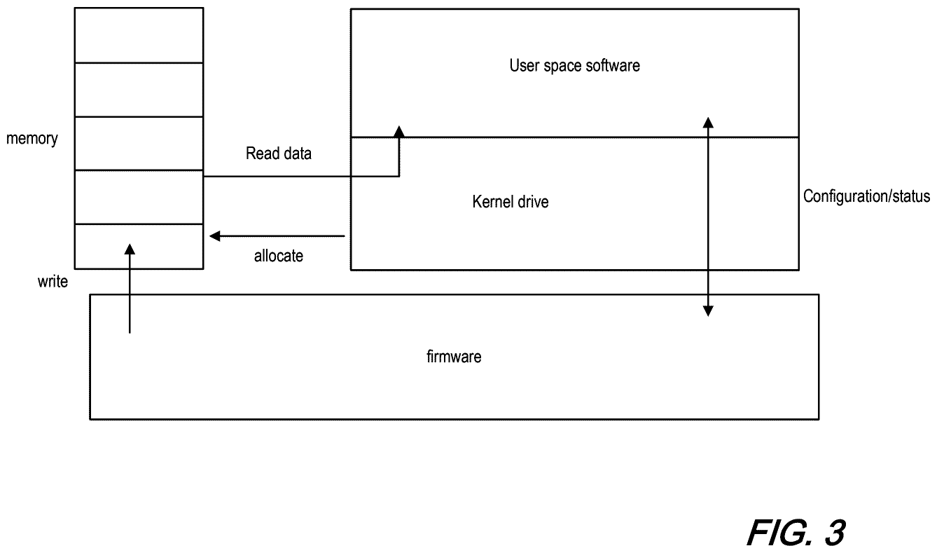

FIG. 3 is a schematic diagram showing illustrative firmware, kernel driver and user space software for systems according to aspects of the present disclosure.

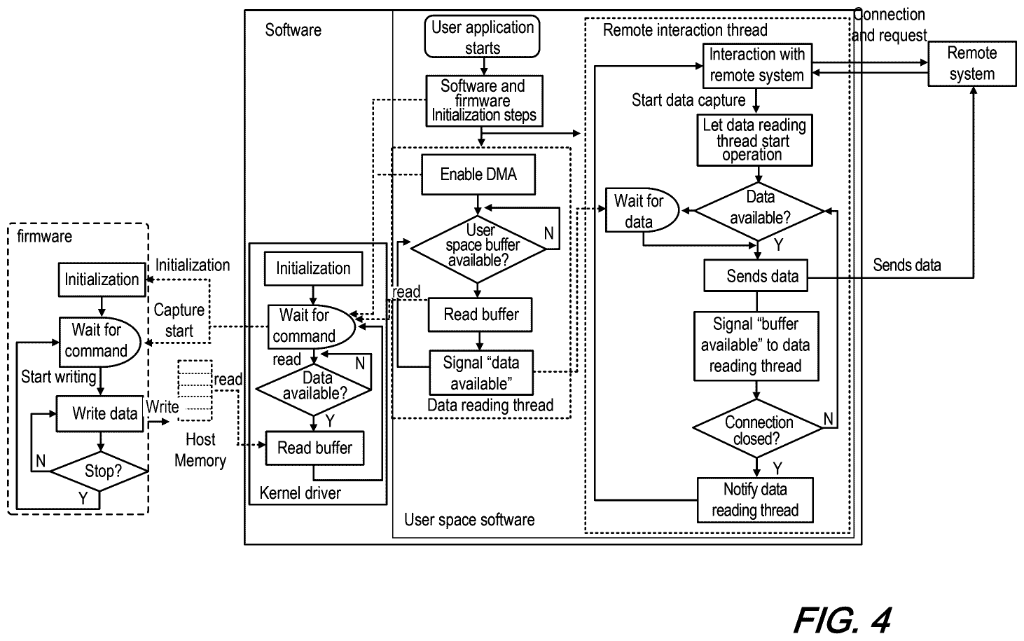

FIG. 4 is a schematic flow diagram showing illustrative processing flow chart according to aspects of the present disclosure.

As noted, FIG. 4 illustrates an overall processing chart, corresponding to the blocks in FIG. 2, that illustrates firmware logic, software, memory that is written by the firmware and read by the software, and remote system. As used, the firmware refers to the RTL (register-transfer level) logic, either implemented in ASIC (Application Specific Integrated Circuit), or in FPGA (Field Programmable Gate Array), while the software refers to the code stored in memory and executed by a processor. The software includes the kernel driver that directly interacts with the firmware, and the user space software that accesses the firmware through the driver and communicates with the remote system. Once the user space software starts executing, it sends commands for system initialization, allocates necessary buffer, and enables two processes to read the data and send to the remote system respectively.

### Firmware

After powering on, the firmware is initialized by the driver according to instructions from executing user space software. The firmware uses scatter-gather DMA (Direct Memory Access) that is configured cyclically, which means the “next pointer” of the last buffer is pointed to the first one. This buffer loop scheme is called “cyclic DMA” and is known in the art.

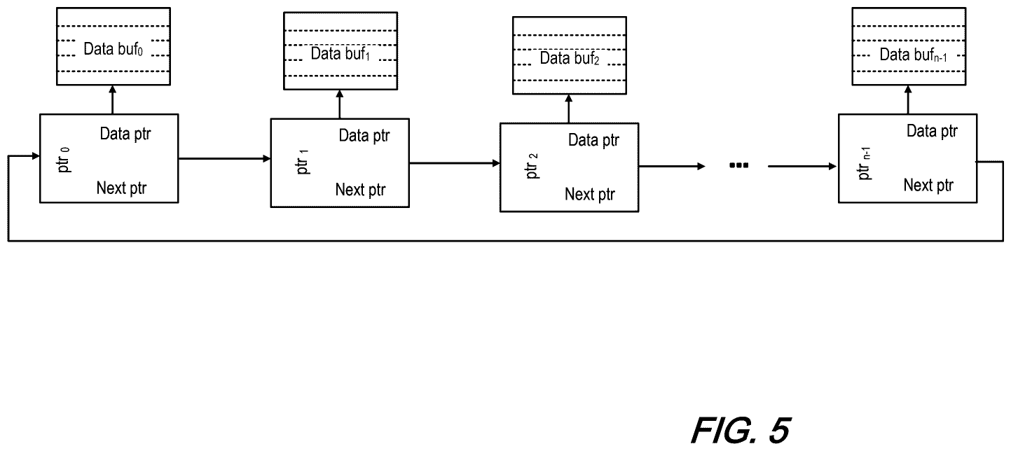

FIG. 5 is a schematic block diagram showing illustrative buffers organized in a loop mode according to aspects of the present disclosure.

In a typical implementation, there is a defined data structure in the firmware that specifies the corresponding data buffer address, and a pointer that can be accessed to access the next data structure. This data structure is configured by the software driver, organized in a cyclic way, as shown illustratively in FIG. 5. This data structure is either located in the host memory, or on-chip memory, or the firmware's directly attached external memory. The data buffer pointed by “data ptr” is allocated in the host memory, of fixed size. Once started, the DMA engine reads the data structure from ptr₀, writes a block of data into data buf₀, then moves to ptr₁, and so on.

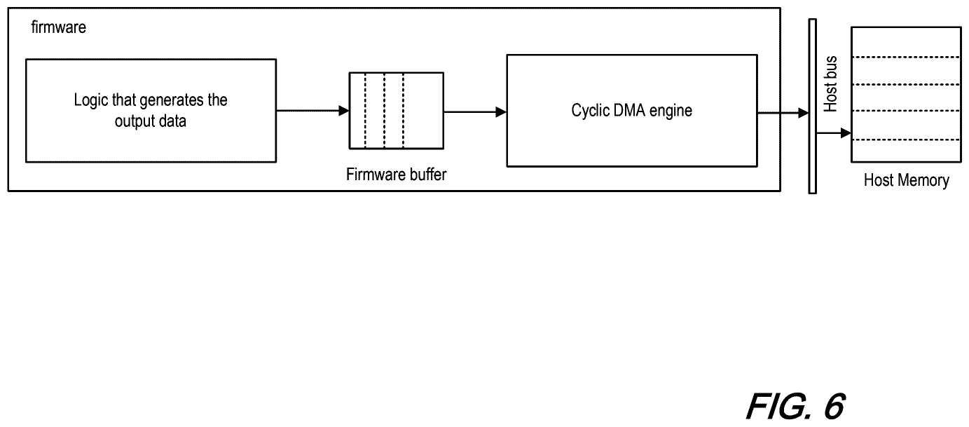

FIG. 6 is a schematic diagram showing illustrative firmware data with output according to aspects of the present disclosure.

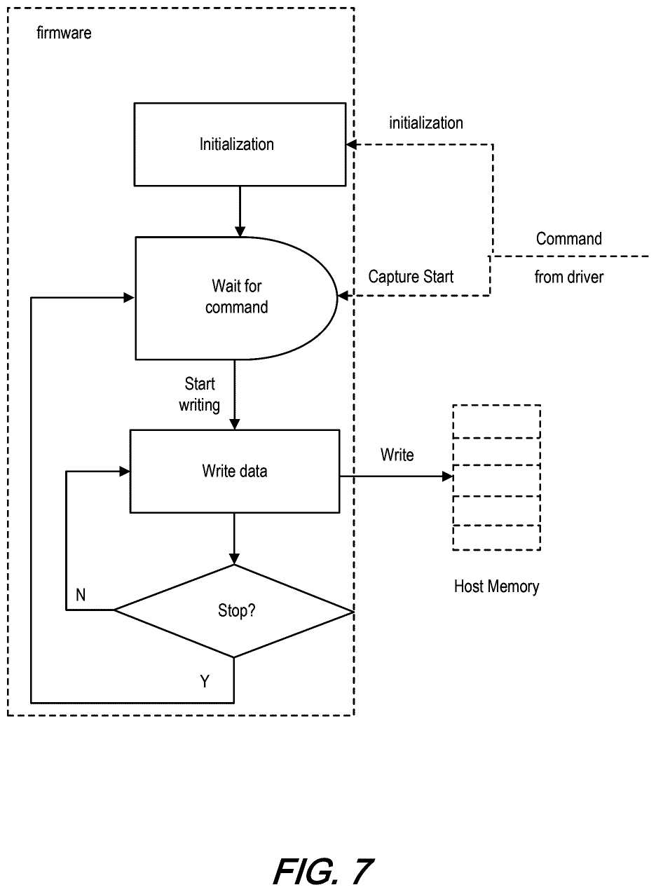

FIG. 6 an illustrative data flow inside the firmware. Real-time output data is written into a buffer, to compensate for the DMA transaction jitter. This buffer can be either on-chip or off-chip. The DMA engine reads from this buffer and handles the host bus access and writes the data into the host memory, which has the address given by “data ptr” shown illustratively in FIG. 5. Once there is instruction to start the transaction, the DMA engine becomes active, and the data generation logic starts writing into the buffer, which is then read by the DMA engine and written into the host memory through the host bus. This operation keeps running until there is instruction from the kernel driver to stop, as shown in FIG. 7.

FIG. 7 is a schematic flow diagram showing illustrative DMA transaction according to aspects of the present disclosure.

As illustrated, data written into the firmware buffer and further into the host memory includes a dedicated field, either at the frame header or at the tail, that contains a “valid” bit and other necessary information. The “valid” bit is used by the software driver to monitor the related DMA memory status, whether there is data to access or not, or overflow. The DMA engine takes no responsibility in this monitoring. The detailed usage is further explained in the “kernel driver”section.

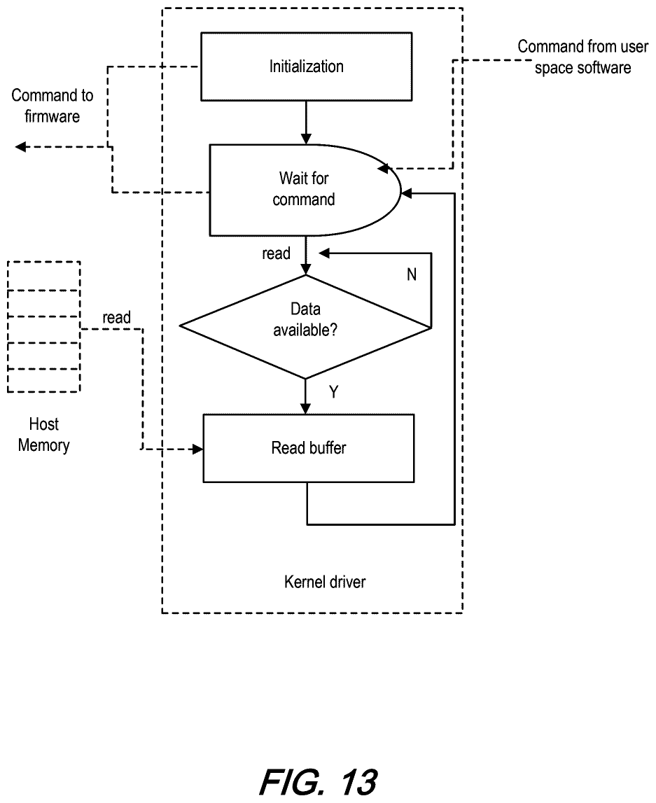

FIG. 8 is a schematic flow diagram showing illustrative kernel driver flow according to aspects of the present disclosure.

### Kernel Driver

The driver software is in the operating system kernel, providing firmware access to the user space software. The processing procedure of the driver is shown in FIG. 7. “Initialization” may include the registration and device emulation with the operation system, and necessary buffer allocation. After initialization, the kernel driver enters “wait for command” mode, to accept instruction from the user space software. The commands include those for the interaction between the user space software and the driver, and for the access to the firmware. If the command is a read data command, then the driver checks the data availability and data buffer status, returns the data when it is available and reports the status, then waits for another command.

The data buffer written by the DMA engine is allocated and maintained by the kernel driver, either according to user space software configuration, or using fixed size. The allocated buffer address is configured to the DMA data structure that is shown in FIG. 5.

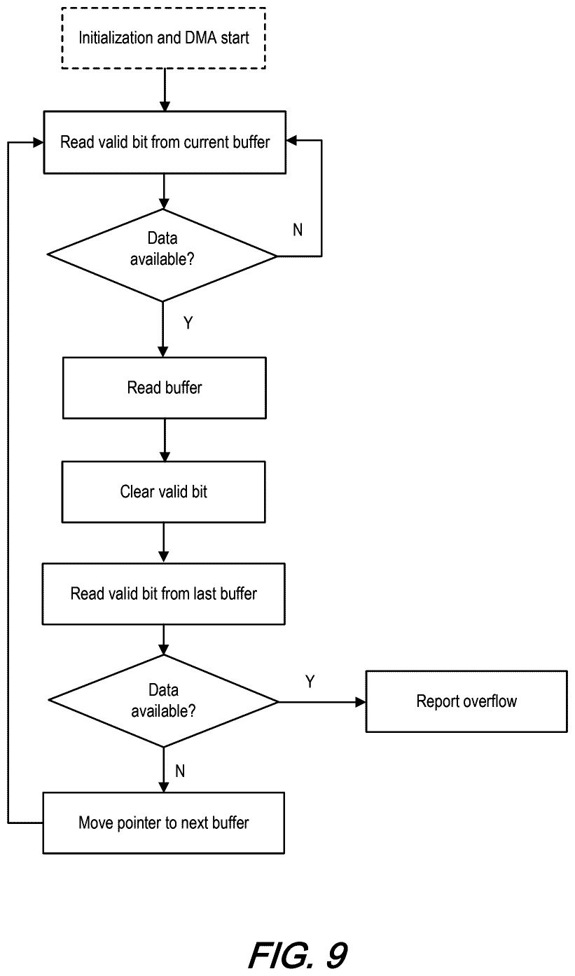

FIG. 9 is a schematic flow diagram showing illustrative memory operation flow in software according to aspects of the present disclosure.

The data written by the firmware includes a “valid” bit indicator that is set to ‘1’. This bit is initialized to zero after the processor allocates the buffer. For each read command from the user space software, the driver continually checks this bit in its current reading pointer. Once this bit becomes ‘1’, it indicates that data is available for reading, so the software reads the buffer and sends to the remote system.

To avoid reading/writing at the same buffer which may cause underflow, if the valid bit is in the header of the written data, the firmware may wait until the valid bit of the next buffer is valid. The software clears this bit after it finishes the reading, then moves to the next buffer. Before reading the current buffer, the software also checks the “valid” bit in the previous one. If this bit is ‘1’, which means the firmware has already started or finished writing the one just read, it's considered that the entire link is full, so the software reports an error to the remote system or performs other necessary operation, such as a firmware pause operation until the read operation catches up.

### User Space Software

The user space software uses two threads, one reads the data from the driver into the user space buffer, and another thread sends the data from the user space buffer to the remote host. The user space buffer is large enough to handle the software and the network jitter. The data reading thread asks the kernel driver to read data whenever the buffer is available, while the data sending thread sends data out whenever there is valid data in this buffer.

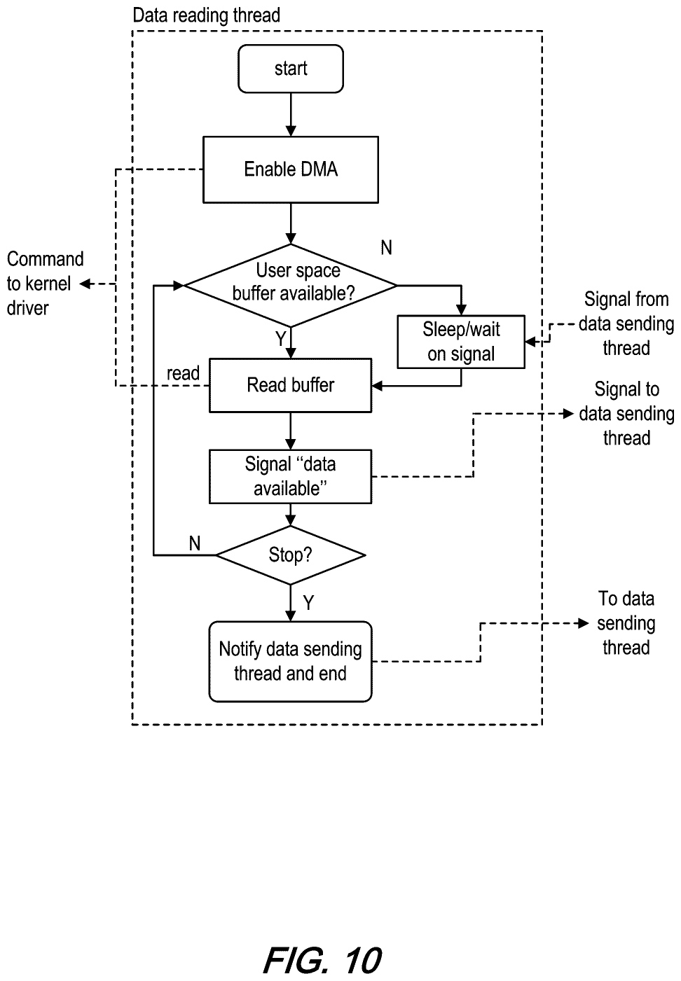

FIG. 10 is a schematic flow diagram showing illustrative data reading thread in user space according to aspects of the present disclosure.

### Data Reading Thread

FIG. 10 illustrates the data reading thread procedure. When initiated, it sends necessary parameters to the kernel driver and requests to enable the DMA engine, then checks the user buffer availability and reads data into the buffer. If buffer space is not available, it may keep on checking or enter wait/sleep mode to be woken up by the data sending thread when buffer is available. After each read, it signals the data sending thread so that the data sending thread can enter sleep mode if data is not available.

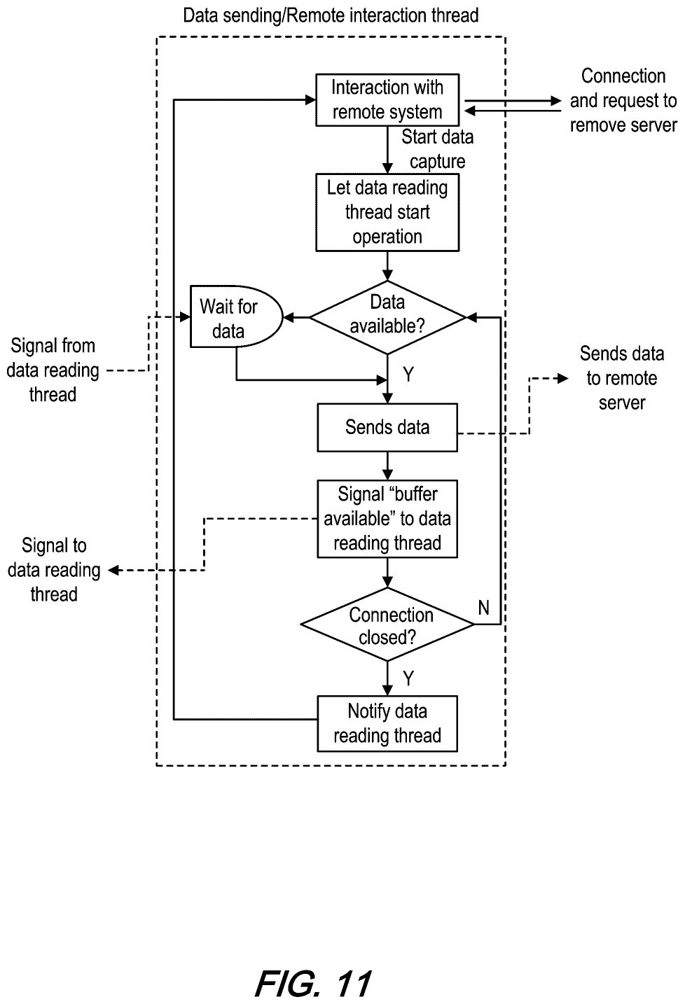

FIG. 11 is a schematic flow diagram showing illustrative data sending thread flow in user space software according to aspects of the present disclosure.

FIG. 11 illustrates the data sending thread. After a connection is established with the remote server, it notifies the data reading thread to start operation, then waits for data. If data is available, it sends data to the remote server, and signals the data reading thread, so it knows the buffer is available. Otherwise, it waits for data availability signal from the data reading thread. The data availability can be known using a counter that is shared between the data reading and data sending thread: when a buffer is read, the counter adds one; when it's sent, the counter is subtracted by one. When the connection is closed, it notifies the data reading thread to stop the transaction, then back to waiting for connection state.

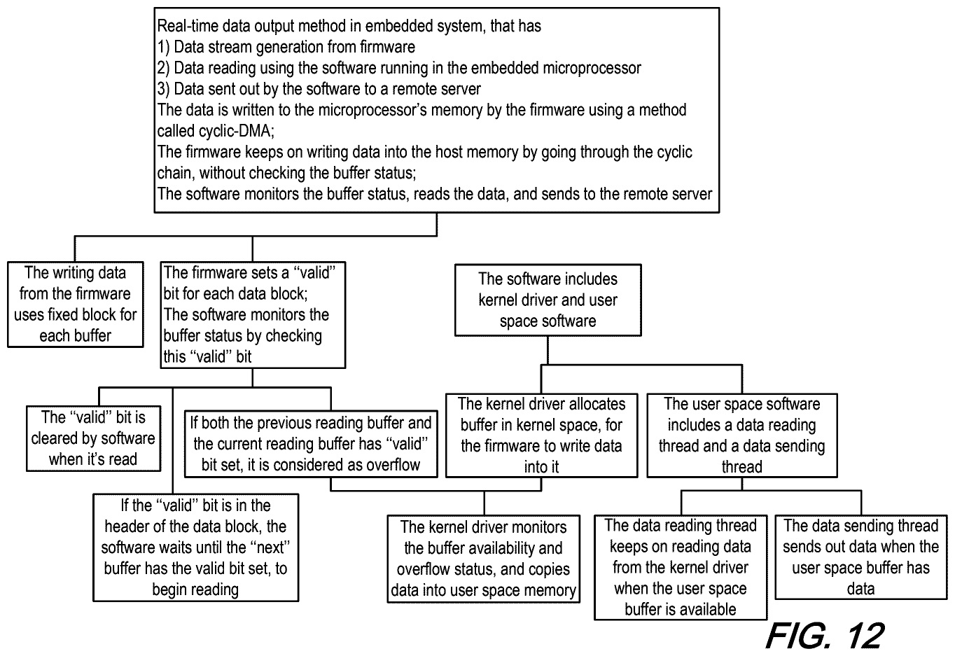

FIG. 12 shows a feature diagram in hierarchical format of illustrative features and operation steps of systems and methods according to aspects of the present disclosure.

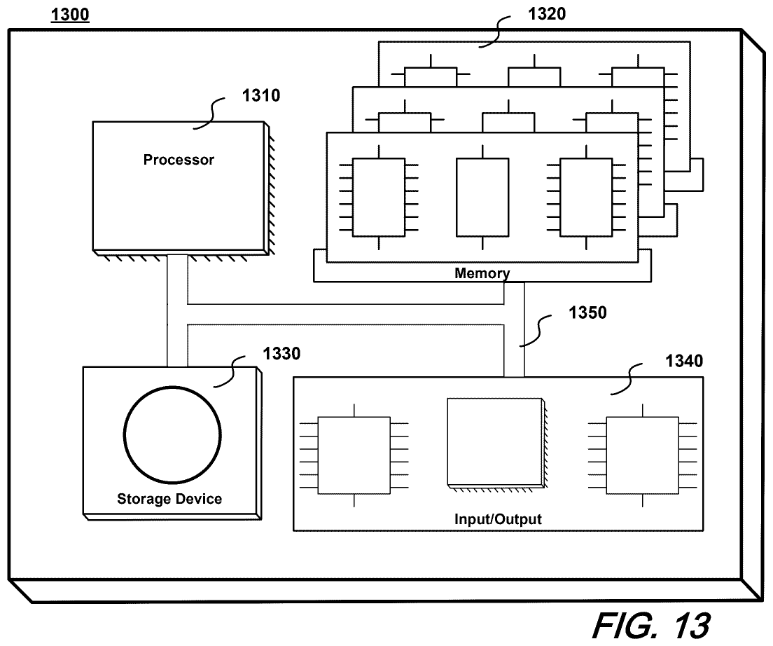

FIG. 13 is a schematic block diagram of an illustrative computer system in which aspects of the present disclosure may be executed to produce methods/algorithms according to aspects of the present disclosure.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on computer system 1300 as stored program control instructions.

Computer system 1300 includes processor 1310, memory 1320, storage device 1330, and input/output structure 1340. One or more input/output devices may include a display. One or more busses 1350 typically interconnect the components, 1310, 1320, 1330, and 1340. Processor 1310 may be a single or multicore. Additionally, the system may include accelerators etc., further comprising the system on a chip.

Processor 1310 executes instructions in which embodiments of the present disclosure may comprise steps described in one or more of the Drawing figures. Such instructions may be stored in memory 1320 or storage device 1330. Data and/or information may be received and output using one or more input/output devices.

Memory 1320 may store data and may be a computer-readable medium, such as volatile or non-volatile memory. Storage device 1330 may provide storage for system 1300 including for example, the previously described methods. In various aspects, storage device 1330 may be a flash memory device, a disk drive, an optical disk device, or a tape device employing magnetic, optical, or other recording technologies.

Input/output structures 1340 may provide input/output operations for system 1300.

While we have presented our inventive concepts and description using specific examples, our invention is not so limited. Accordingly, the scope of our invention should be considered in view of the following claims.

1. A computer-implemented method for transferring data from a distributed fiber optic sensing system (DFOS) to a remote system for processing, the method comprising:
writing DFOS data directly into an embedded host memory,
copying, the DFOS data from the embedded host memory to a user space memory,
requesting, by a first dedicated user space thread, the DFOS data copied to the user space memory,
sending, by a second dedicated user space thread, the DFOS data copied to the user space memory to the remote system.

2. The method of claim 1 wherein the DFOS data is copied from the embedded host memory to the user space memory using a cyclic Direct Memory Access (cyclic DMA) technique.

3. The method of claim 2 wherein the writing and copying of the DFOS data into the user space memory is controlled by a valid bit that is set by firmware and cleared by software.

4. The method of claim 3 wherein the writing of the DFOS data is performed by firmware operating at a register-transfer level.

5. The method of claim 4 wherein the user space memory to which the firmware writes the DFOS data is configured as a buffer, divided into multiple frames, each frame includes a valid bit that is set by firmware and cleared by software, the valid bit indicative of both a valid status and a full status.
